(19) United States
(12) Patent Application Publication
(10) Pub. No.: US 2024/0428153 A1
(43) Pub. Date: Dec. 26, 2024

(54) ENRICH THE WFM-SHIFT TRADE EXPERIENCE FOR AGENTS AND MANAGERS BY INTRODUCING THE SHIFT TRADE INDEX

(71) Applicant: NICE LTD., Ra’anana (IL)

(72) Inventors: Gaurav SURYAWANSHI, Pune (IN); Laukik PATIL, Bhiwandi (IN); Shilpa SHEGAONKAR, Pune (IN)

(21) Appl. No.: 18/338,764

(22) Filed: Jun. 21, 2023

(51) Int. Cl. G06Q 10/0631

(52) U.S. Cl. CPC G06Q 10/063116

(57) ABSTRACT

Shift trading systems and methods, and non-transitory computer readable media, include receiving a shift trade request from a source agent, wherein the shift trade request comprises a shift day and a shift time; matching the shift trade request with a plurality of target agents that are available on the shift day and the shift time; for each target agent from the plurality of target agents, calculating a trade index score based on a trade history success index score, a matching skill index score, a skill proficiency index score, and a trade interval index score; ranking the plurality of target agents from highest to lowest trade index score; and displaying the ranked plurality of target agents with the target agent having the highest trade index score at the top of a list.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates generally to methods and systems for facilitating the trading of shifts between agents, and more particularly to methods and systems that calculate a trade index score to assist an agent in selecting a proper target agent and a manager in approving a trade request.

### BACKGROUND

Agents in a contact center are scheduled on a particular shift based on contact center staffing requirements. These agents may want some flexibility in their working shifts as they may not be available at certain times due to various reasons.

Due to the unavailability of an agent for a specific working day, an agent can try to trade his/her work schedule with another agent using a workforce management (WFM) system. WFM is an integrated set of processes that a company uses to optimize the productivity of its employees. For example, WFM includes applications that enable contact center management to forecast workloads and align staffing needs around those forecasts. WFM systems are specialized systems that track time and attendance of agents, schedule agent shifts, forecast future workloads, and assign the appropriate number of agents to shifts.

In current WFM systems, there is a trading functionality where agents can trade their entire shifts or particular segments of their shifts for more flexibility in their schedules. Agents can trade between the same or even different scheduling units and time zones if the pre-set configurations allow. When an agent requests a trade while mentioning his/her required shift times, however, he/she gets a large list of eligible agents from whom he/she has to pick.

The agent must then manually go and select the agents to trade with from the list. This can lead to unnecessary trade requests sent to uninterested candidates. The agent has no idea if the trade will succeed or fail, or if this request will be accepted by any agents.

If none of the agents accept the trade request, the agent requesting the trade may end up taking a day off, which would indirectly affect the staffing conditions in the contact center. In short, the agent is clueless if the trade request that he/she is making will be a success or not.

Each trade request is further sent to a manager for manual approvals. Managers can view any trade request that is made before approving or declining it. The manager can see which agent is trading with whom, along with the date and time of the trade. This information, however, is not sufficient for managers to make wise decisions. Managers cannot decide the approval based only on the shift timings. Managers tend to also look at other criteria that is important to consider when determining whether to accept or decline a trade request.

Problems in shift trading can lead to management reluctance to permit shift trades, reduced flexibility for contact center agents, and can eventually lead to discontent at the contact center. Accordingly, there is a need for a solution that improves the trading of shifts between agents and manager approval of the trade shifts.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of an embodiment of an agent shift trading system according to embodiments of the present disclosure.

FIG. 2 is an exemplary agent user interface according to embodiments of the present disclosure.

FIG. 3 is an exemplary manager user interface according to embodiments of the present disclosure.

FIG. 4 illustrates an exemplary method of calculating the trade index score according to embodiments of the present disclosure.

FIG. 5 illustrates an exemplary agent automatic shift trade approval method according to embodiments of the present disclosure.

FIG. 6 illustrates an exemplary manager automatic shift trade approval method according to embodiments of the present disclosure.

FIG. 7 is a flowchart of a method according to embodiments of the present disclosure.

FIG. 8 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The present systems and methods provide a trade index score to an agent who is requesting a trade in shifts (referred to herein as the “source agent”). In one or more embodiments, when a source agent requests a trade, after entering his/her preferences of days and times, the source agent gets a list of matching target agents. This list of target agents is displayed based on the trade index score configurations, and the best match is displayed at the top of the list. Advantageously, these details are seen on the trade shift webpage before the source agent sends a trade request to any other agents or a manager. This helps source agents estimate the probability of having a successful trade and to choose the best match options.

According to various embodiments, the trade index score is based on various factors including skills match, skill proficiency match, historic trade approvals, past no-shows, if any, and shift lengths of the source and the target agent. In one or more embodiments, an additional column is now provided on the source agent's trade shift webpage. The webpage may thus additionally display the trade index score that was calculated considering the various factors to help the source agent select the most suitable target agents for their trade request.

When a trade request is accepted by a target agent and sent to the manager for approval, the manager is able to view the request. This gives the manager clarity on the date, time and shifts being exchanged, but typically no criteria to make an informed decision is given.

In certain embodiments, an enhanced manager view for a trade request is provided. The present systems and methods display the trade index score, skill and proficiency match, history of trade, and the shift length difference to the manager so that the manager can make an informed decision whether or not to approve the trade request.

In several embodiments, trade index score calculations are used for automatic approvals of trade requests. In some embodiments, the manager configures the upper and lower threshold limits of the trade index score. Once the automatic approval is “ON” at the tenant level, trade requests can be automatically approved, which can save a lot of time for managers.

Advantageously, source agents can trade with multiple target agents from various scheduling units, time zones, or both. Source agents can now correctly identify the most eligible target agents for their shift trade requests. Source agents need not randomly pick and choose the target agents and their shift, but the system permits the source agent to utilize the calculated information provided and increase the likelihood of the trade request getting approved and being successful before even sending the request to trade shifts. The effect of the present systems and methods spans across the source agent's engagement. Also, there is less “spamming” of trade requests to the other contact center agents, and only interested and suitable target agents will even receive the trade requests. For example, if an agent has substandard performance for a time period or is on an initial probationary period, a manager might optionally remove the ability for that agent to trade shifts. Such an agent would not receive target agent requests.

In various embodiments, the skills of agents are reviewed when two agents try to trade their shifts. If the skills match, the manager can also evaluate the proficiency levels of the agents for that skill.

According to one or more embodiments, proficiency levels of the agents to be matched are considered before they trade. Proficiency levels are very important to provide a good experience to customers, despite the shift being traded with another agent. If the agent's trade shift is exchanged with a peer having the same skills with minimal difference in the proficiency score, customers will tend to have a more seamless experience. In one or more embodiments, proficiency levels are matched and maintained even after the agents have exchanged their shifts.

Moreover, the manager can more readily consider the shift lengths being exchanged. For example, the manager can check if a one hour shift is being traded for a five hour shift, and which ones would be the best match or should be permitted. Some agents may not be suited to long shifts, and the system can be pre-configured to decline trades that might result in such a target agent having too long a shift to remain at a desirable level of performance. In various embodiments, another important aspect being checked is if there were no-shows in the past by the target agent, which will help avoid any non-adherence activities in the future. Use of the trade index score reduces the number of no-shows and hence reduces the impact on staffing levels in the contact center.

The present systems and methods provide a win-win situation for all, i.e., the agents trading and the manager, as well. Agents are shown the best-suited options to trade with as per their criteria. An enhanced view of all the parameters are provided to a manager to make a wise (i.e., sufficiently informed) decision before accepting/rejecting a trade request. Excellent customer experience is maintained even after agents have traded their shifts since the target agents have the same skills with similar proficiency levels.

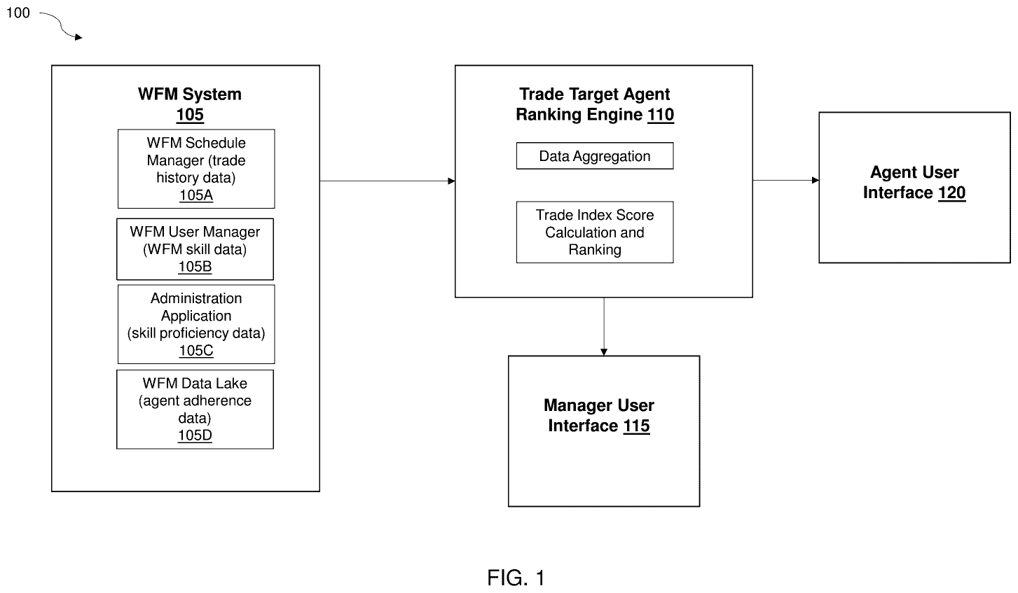

FIG. 1 illustrates an agent shift trading system 100 and a system flow for a method according to the present disclosure. As shown, WFM system 105 stores various applications, which hold the data for agents' trade history, skills, proficiencies, and adherence. In particular, WFM system 105 includes WFM Schedule Manager 105A, which stores trade history data, WFM User Manager, which stores WFM skill data, Administration Application 105C, which stores skill proficiency data, and WFM Data Lake, which stores agent adherence data. Adherence data includes information whether a shift was successfully carried out by the source agent and the target agent (in-adherence) or whether the shift was not successfully carried out by the source agent and the target agent (non-adherence or no-show). The applications provide input to trade target agent ranking engine 110.

Trade target agent ranking engine 110 aggregates the data along with the input configuration parameters and calculates the trade index score per target agent. The trade index score is computed based on application data and also based on the weighted mean formulation of configuration parameters set by managers.

The output generated by trade target agent ranking engine 110 includes the ranked list of target agents based on the trade request and the trade index score. This output is sent to agent user interface 120, which is the user interface that an agent uses to view target agents for a trade request. The output is also sent to the manager user interface 115, which is the user interface for a manager to view trade requests along with trade index scores for approvals.

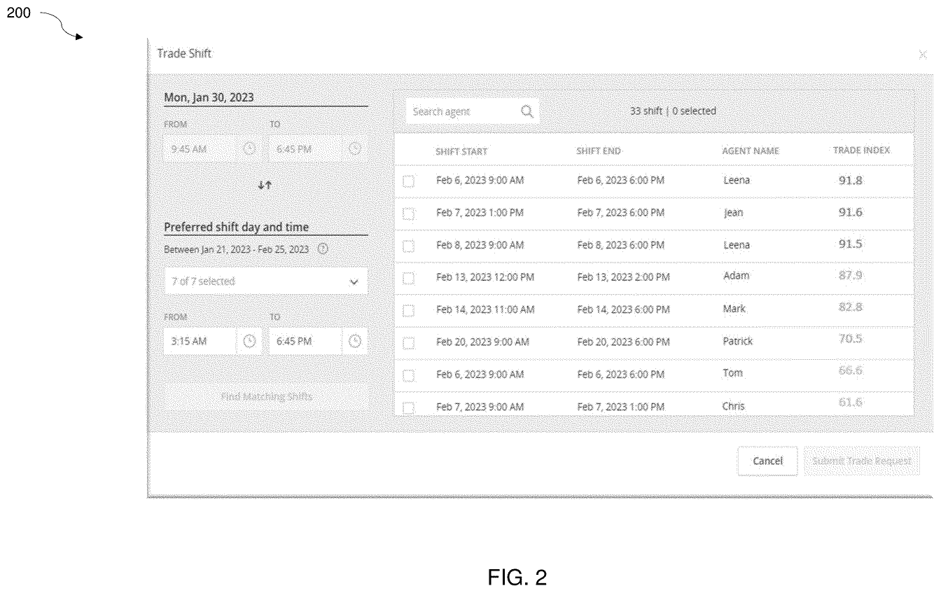

Referring now to FIG. 2, an exemplary embodiment of a trade shift webpage 200 displayed to an agent is shown. In one embodiment, once the source agent selects the date for a trade request and inputs his/her preferences of days and times on the left section of the webpage 200, the list of target agents as per the trade configurations and preferences are generated on the right side of the webpage 200. The target agent having the highest trade index score is placed at the top of the list. Depending on the trade index score, source agents can select the target agents to trade with. This increases the probability of a successful trade request, which the system displays to the source agent before sending any trade request.

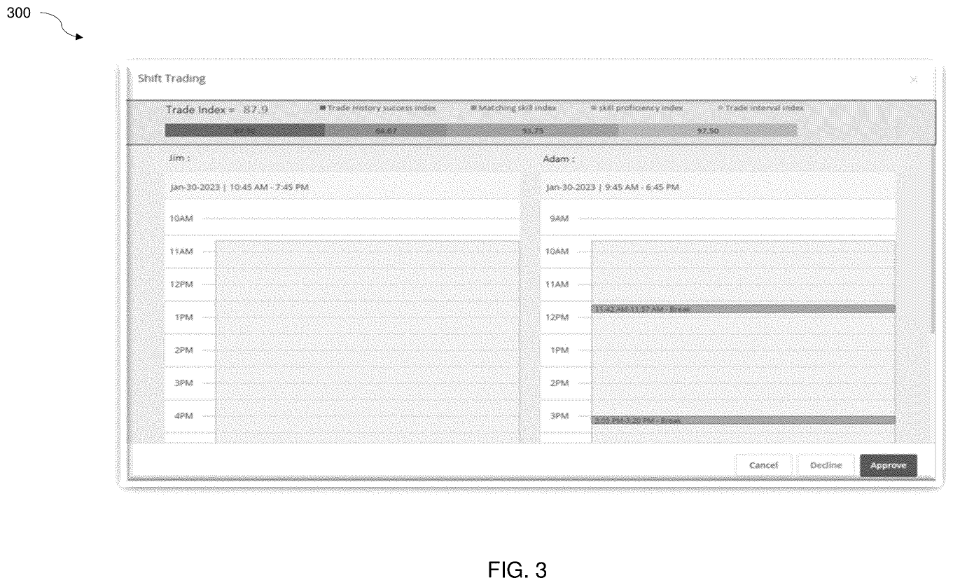

The trade index score also serves as input to managers for approving trade requests. Referring now to FIG. 3, an exemplary embodiment of a shift trading webpage 300 displayed to a manager is shown. In this embodiment, in addition to the trade index score, the trade history success index score, the matching skills index score, the skill proficiency index score, and the trade interval index score are also displayed to the manager. These trade index parameters provide the manager with more details regarding the trade index score. Once the manager approves the trade request (or the trade request is approved automatically), the respective agents' schedules are changed.

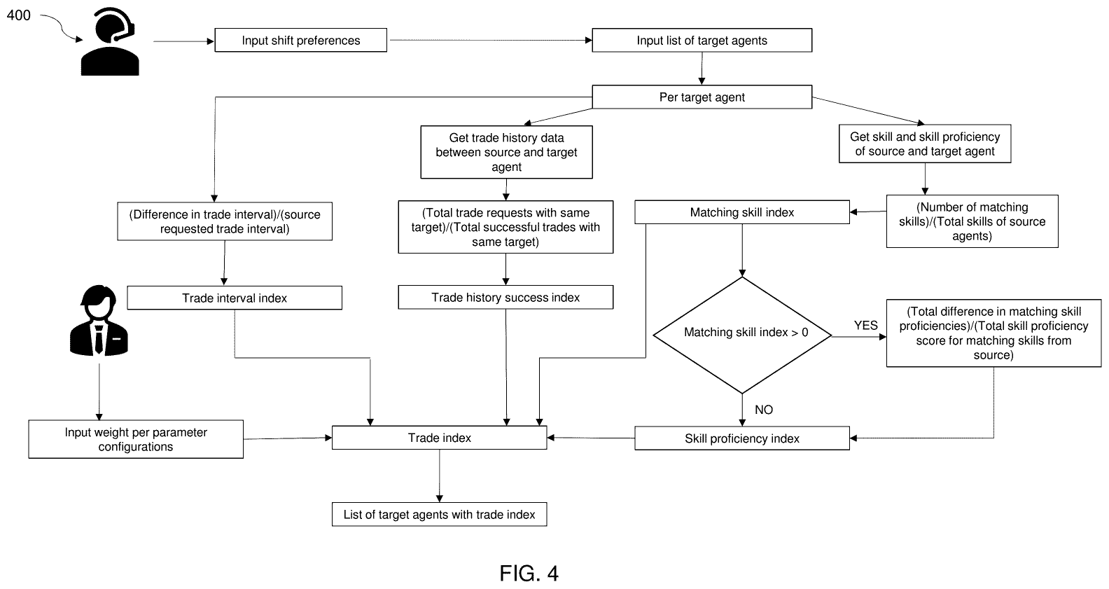

FIG. 4 illustrates an exemplary method 400 of calculating the trade index score according to embodiments of the present disclosure. Initially, a source agent inputs the preferred day and time for the shift he/she wants to trade. Based on these shift preferences, a list of available target agents is generated.

For each target agent, trade history data between the source agent and the target agent is obtained to calculate the trade history success index score. The inputs needed to calculate the trade history success index score include the past trade history that can be obtained from the WFM Schedule Manager 105A and the target agent user ID. Trade target agent ranking engine 110 searches for trade requests between the source agent and the target agent (nt) and successful trade requests between the source agent and the target agent (nst). A successful trade request is a request where the target agent accepts the trade request and the manager approves the trade request. The trade history success index score is calculated as (nst/nt)*100.

In some embodiments, a separate adherence index score is calculated, which takes into account no-shows of the target agent. The inputs needed to calculate the adherence index score include the past trade history that can be obtained from the WFM Schedule Manager 105A and the target agent user ID, and adherence of the source and target agent to past trade requests that can be obtained from WFM Data Lake 105D.

For each target agent, skill and skill proficiencies of the source and target agent are obtained to calculate the matching skill index score. The input needed to calculate the matching skill index score is the source and target agent skill that can be obtained from the WFM User Manager 105B. Trade target agent ranking engine 110 searches for matching skills between the source agent and the target agent (ms) and the total skills of the source agent (ts). The matching skill index score is calculated as (ms/ts)*100.

For matching skill index scores greater than zero, the skill proficiency index score is calculated. The inputs need to calculate the skill proficiency index score are the source agent skill proficiencies and target agent skill proficiencies for matching skills that can be obtained from Administration Application 105C. Trade target agent ranking engine 110 adds the skill proficiencies of the source agent for matching skills (sp), adds the skill proficiencies of the target agent for matching skills (tp), and calculates the absolute difference in skill proficiencies (dsp)=|sp-tp|. The skill proficiency index score is calculated as (dsp/sp)*100.

For each target agent, the trade interval index score is calculated. The inputs needed to calculate the trade interval index score are the source agent shift and the target agent shift that can be obtained from WFM Schedule Manager 105A. Trade target agent ranking engine 110 calculates the shift lengths of the source agent (ssl) and target agent (tsl), and calculates the absolute difference in shift lengths (dsl)=|ssl-tsl|. The trade interval index score is calculated as (dsl/ssl)*100.

Trade target agent ranking engine 110 calculates the trade index score from the trade index weights that can be obtained from WFM Schedule Manager 105A (w1+w2+w3+w4) and the trade interval index score (A), the trade history success index score (B), the matching skill index score (C), and the skill proficiency index score (D). The trade index score is calculated as (A*w1+B*w2+C*w3+D*w4)/(w1+w2+w3+w4). In various embodiments, the manager decides the weight of each factor for the calculation of the trade index score.

In embodiments where the adherence index score is included, the trade index score is calculated as (A*w1+B*w2+C*w3+D*w4+E*w5)/(w1+w2+w3+w4+w5). The adherence index score is represented in the equation as E and its corresponding weight is w5.

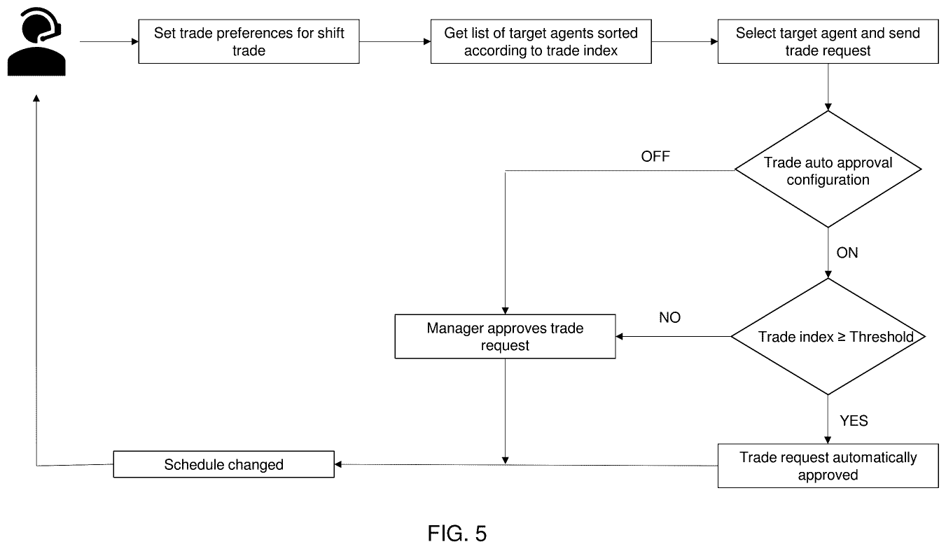

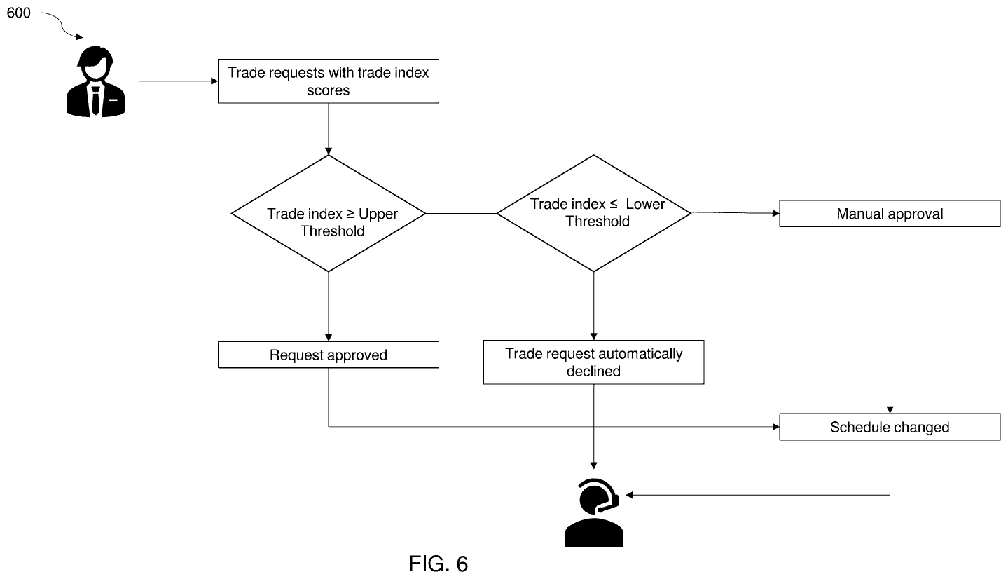

Referring now to FIGS. 5 and 6, an exemplary agent automatic shift trade approval method 500 and an exemplary manager automatic shift trade approval method 600 is illustrated. In various embodiments, managers can set the conditions for automatic approval, automatic decline, and/or manual approval depending on the trade index score or any or all of its four (or five) factors (i.e., trade interval index score, trade history index score, matching skill index score, skill proficiency index score, and adherence index score). In various embodiments, a manager can configure the upper and lower threshold values for the trade index score and/or the trade index factors or parameters.

Initially, the source agent opens the trade shift webpage 200 and selects his/her shift preferences. Trade target ranking engine 110 provides the list of agents that match these shift preferences with their respective trade index scores and displays them on agent user interface 120. The source agent selects his/her preferred target agent from the list on agent user interface 120. Ideally, the source agent should select the target agent with the maximum trade index score. The trade request is then sent to the target agent, and the target agent approves the trade request.

The manager sees the trade request with the trade index score distribution. If the automatic approval conditions and rules are set by the manager, then the trade request will first get evaluated for automatic approval. The manager will not be required to act if the trade request is automatically approved. As shown in FIGS. 5 and 6, the trade request is automatically approved if the trade index score is greater than or equal to a threshold score. If the trade index score is less than the threshold score, the manager can still manually approve the trade request. In FIG. 6, if the trade index score is less than a lower threshold score, the trade request is automatically declined. The manager may modify the various criteria described herein to provide for a narrower or broader range of managerial discretion, as desired, between the original configurations under which the systems and methods will automatically approve or reject a trade request.

After the manager manually approves the trade request or after the trade request is automatically approved, the schedules for the source and target agents are updated and changed according to the requested trade shift. WFM system 105 notifies the agents about the change in schedule and the approval of the trade request.

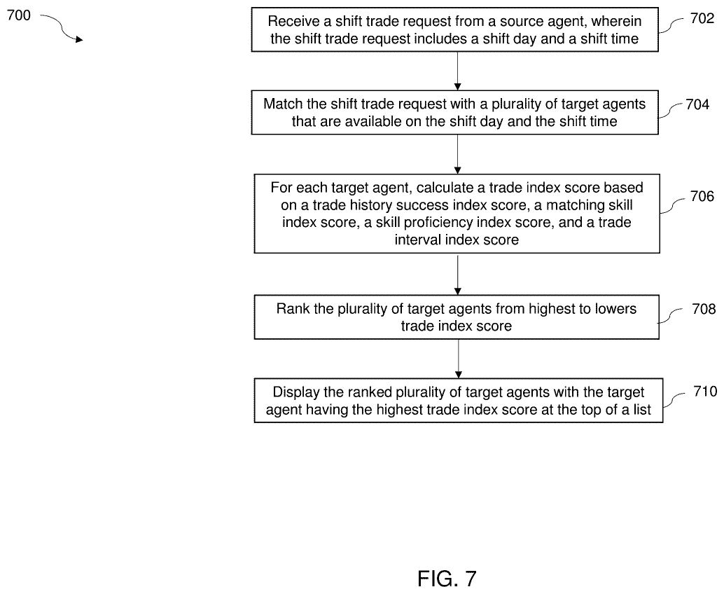

Referring now to FIG. 7, a method 700 according to various embodiments of the present disclosure is described. At step 702, WFM system 105 receives a shift trade request from a source agent. The shift trade request includes a shift day and a shift time.

At step 704, WFM system 105 matches the shift trade request with a plurality of target agents that are available on the shift day and the shift time.

At step 706, trade target agent ranking engine 110 calculates a trade index score for each target agent from the plurality of target agents. The trade index score is based on a trade history success index score, a matching skill index score, a skill proficiency index score, and a trade interval index score. In certain embodiments, the trade index score is further based on an adherence index score. In one or more embodiments, trade target agent ranking engine 110 is integrated into WFM system 105, for example, in WFM Schedule Manager 105A.

In some embodiments, calculating the trade index score includes receiving a weight for each of the trade history success index score, the matching skill index score, the skill proficiency index score, and the trade interval index score, and applying the respective weight to each of the trade history success index score, the matching skill index score, the skill proficiency index score, and the trade interval index score. In embodiments where the trade index score includes the adherence index score, calculating the trade index score further includes receiving a weight for the adherence index score, and applying the respective weight to the adherence index score.

At step 708, trade target agent ranking engine 110 ranks the plurality of target agents from highest to lowest trade index score.

At step 710, agent user interface 120 displays the ranked plurality of target agents with the target agent having the highest trade index score at the top of the list.

In several embodiments, method 700 further includes receiving, from the source agent, a selection of a target agent from the list of target agents on agent user interface 120, transmitting the shift trade request to the selected target agent, and receiving, from the selected target agent, an acceptance of the shift trade request.

In some embodiments, once the shift trade request is accepted by the selected target agent, the shift trade request is transmitted to a manager, and the trade index score, the trade history success index score, the matching skill index score, the skill proficiency index score, and the trade interval index score are displayed on manager user interface 115.

In various embodiments, after the manager views the shift trade request, the manager approves of the shift trade request, and WFM system 105 changes the schedule of the source agent and the selected target agent according to the shift trade request. In certain embodiments, WFM system 105 notifies the source agent and the target agent about the change in schedule.

In one or more embodiments, WFM system 105 receives, from the manager, an upper threshold value and/or a lower threshold value for one or more of the trade index score, the trade history success index score, the matching skill index score, the skill proficiency index score, or the trade interval index score. In embodiments where the trade index score is also based on the adherence index score, WFM system 105 can also receive an upper threshold value and/or a lower threshold value for the adherence index score. In several embodiments, WFM system 105 determines that the trade index score is greater than or equal to the upper threshold value for the trade index score and WFM system 105 automatically approves the shift trade request. In some embodiments, WFM system 105 determines that the trade index score is lower than or equal to the lower threshold value for the trade index score and WFM system 105 automatically rejects or declines the shift trade request.

Below is an example calculation of the trade index score according to embodiments of the present disclosure.

1A. Trade history success index -

```
  Inputs (WFM DB): -
      {
      ″Source Agent Name″: “Jim”,
      ″Target Agent Name″: “Adam”
      ″Trade history″: 8
      ″Successful Trade History″ : 6
      }
  Total historical trade request = 8
  Successful trade requests = 6
Trade history success index = (6/8) * 100 = 75
```

1B. Adherence index score (for Manager View) -

| | |
|---|---|
| | For all successful trade requests( 6 ) get adherence of Source |
| | and Target |
| | { |
| | ″Agent Name″ : “Jim”, |
| | ″Adherence score″: 100 |
| | ″Date″: “2023-04-15” |
| | } |
| | { |
| | ″Agent Name″ : “Adam”, |
| | ″Adherence score″: 100 |
| | ″Date″: “2023-04-15” |
| | } |
| | From a total of 6 successful trades only 5 were having 100% |
| | adherence. |
| | Successful Trade requests with adherence = 5 |
| | Adherence Index = (5/8)*100 = 62.5 |
| 2. | Matching skill index - |
| | Inputs (WFM DB) |
| | { |
| | ″Agent Name″ : “Jim”, |
| | ″Skills″:[“chat”, “email” ,”voice”] |
| | } |
| | { |
| | ″Agent Name″ : “Adam”, |
| | ″Skills″: [“chat”, “email” ,”dial”] |
| | } |
| | Total skills = 3 |
| | Matching skills = 2 |
| | Matching skill index = (2/3)*100 = 66.67 |
| 3. | Skill proficiency index - |
| | Input - |
| | { |
| | ″Agent Name″ : “Jim”, |
| | ″SkillProficiency″:{ “chat”: 5, “email”: 7,”voice” : 4 } |
| | } |
| | { |
| | ″Agent Name″, |
| | ″SkillProficiency″: { “chat”: 5, “email”: 8 ,”dial” : 9 } |
| | } |
| | Source agent Skill proficiency = 7 + 5 = 12 |
| | Target agent Skill proficiency = 5 + 8 = 13 |
| | Difference in skill proficiencies for matching skills = 12−13 = 1 |
| | Matching skill proficiency index = [1−(1/12)] * 100 = 91.67 |
| 4. | Trade Interval Index - |
| | Input - |
| | { |
| | ″Agent Name″: “Jim”, |
| | ″shift length″: 8 |
| | } |
| | { |
| | ″Agent Name″: “Adam”, |
| | ″shift length″: 8 |
| | } |
| | Source Agent shift length = 8 |
| | Target Agent shift length = 8 |
| | Trade Interval Index = [1−\|8−8\|/8] *100 = 100 |
| 5. | Trade Index - |
| | Inputs - |
| | Trade history success index = 75 |
| | Matching skill index = 66.67 |
| | Skill proficiency index = 91.67 |
| | Trade interval index = 100 |
| | Adherence index = 80 |
| | Weights set by Manager - |
| | { |
| | ″Trade history success index wt″: 8, |
| | ″Matching skill index wt″: 10, |
| | ″Skill Proficiency index wt″: 7, |
| | ″Adherence score wt″: 8, |
| | ″Shift length wt″: 2 |
| | } |
| | Trade Index = (8*75 + 10*66.67 + 7*91.67 + 2*100 + 8*80)/ |
| | (8+10+7+2 + 8) = |
| | 78.54 |
| | Output - |
| | { |
| | ″Source Agent Name″: “Jim”, |
| | ″Target Agent Name″: “Adam”, |
| | ″Trade Start and End date″: “2023-04-23”, |
| | ″Trade history success index score”: 75, |
| | ″Matching skill index score″: 66.67, |
| | ″Skill proficiency index score″: 91.67, |
| | ″Trade interval index″: 100, |
| | ″Adherence score″: 62.5, |
| | ″Trade index″: 78.54 |
| | } |

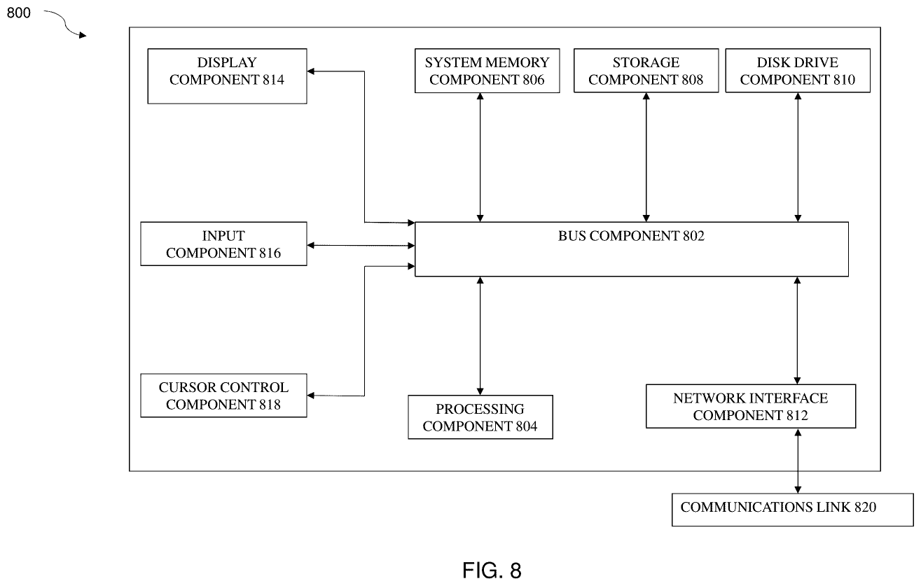

Referring now to FIG. 8, illustrated is a block diagram of a system 800 suitable for implementing embodiments of the present disclosure. System 800, such as part of a computer and/or a network server, includes a bus 802 or other communication mechanism for communicating information, which interconnects subsystems and components, including one or more of a processing component 804 (e.g., processor, micro-controller, digital signal processor (DSP), etc.), a system memory component 806 (e.g., RAM), a static storage component 808 (e.g., ROM), a network interface component 812, a display component 814 (or alternatively, an interface to an external display), an input component 816 (e.g., keypad or keyboard), and a cursor control component 818 (e.g., a mouse pad).

In accordance with embodiments of the present disclosure, system 800 performs specific operations by processor 804 executing one or more sequences of one or more instructions contained in system memory component 806. Such instructions may be read into system memory component 806 from another computer readable medium, such as static storage component 808. These may include instructions to receive a shift trade request from a source agent, wherein the shift trade request comprises a shift day and a shift time; match the shift trade request with a plurality of target agents that are available on the shift day and the shift time; for each target agent from the plurality of target agents, calculate a trade index score based on a trade history success index score, a matching skill index score, a skill proficiency index score, and a trade interval index score; rank the plurality of target agents from highest to lowest trade index score; and display the ranked plurality of target agents with the target agent having the highest trade index score at the top of a list. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 804 for execution. Such a medium may take many forms, including but not limited to, non-volatile media, volatile media, and transmission media. In various implementations, volatile media includes dynamic memory, such as system memory component 806, and transmission media includes coaxial cables, copper wire, and fiber optics, including wires that comprise bus 802. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 800. In various other embodiments, a plurality of systems 800 coupled by communication link 820 (e.g., LAN, WLAN, PTSN, or various other wired or wireless networks) may perform instruction sequences to practice the disclosure in coordination with one another. Computer system 800 may transmit and receive messages, data, information and instructions, including one or more programs (i.e., application code) through communication link 820 and communication interface 812. Received program code may be executed by processor 804 as received and/or stored in disk drive component 810 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. An agent shift trading system comprising:
a processor and a computer readable medium operably coupled thereto, the computer readable medium comprising a plurality of instructions stored in association therewith that are accessible to, and executable by, the processor, to perform operations which comprise:
receiving a shift trade request from a source agent, wherein the shift trade request comprises a shift day and a shift time;
matching the shift trade request with a plurality of target agents that are available on the shift day and the shift time;
for each target agent from the plurality of target agents, calculating a trade index score based on a trade history success index score, a matching skill index score, a skill proficiency index score, and a trade interval index score;
ranking the plurality of target agents from highest to lowest trade index score; and
displaying the ranked plurality of target agents with the target agent having the highest trade index score at the top of a list.

2. The shift trading system of claim 1, wherein calculating the trade index score comprises:
receiving a weight for each of the trade history success index score, the matching skill index score, the skill proficiency index score, and the trade interval index score; and
applying the respective weight to each of the trade history success index score, the matching skill index score, the skill proficiency index score, and the trade interval index score.

3. The shift trading system of claim 1, wherein the operations further comprise:
receiving, from the source agent, a selection of a target agent;
transmitting the shift trade request to the selected target agent; and
receiving, from the selected target agent, an acceptance of the shift trade request.

4. The shift trading system of claim 3, wherein the operations further comprise:
transmitting the shift trade request to a manager; and
displaying the trade index score, the trade history success index score, the matching skill index score, the skill proficiency index score, and the trade interval index score to the manager.

5. The shift trading system of claim 4, wherein the operations further comprise:
receiving, from the manager, approval of the shift trade request; and
changing a schedule of the source agent and the selected target agent according to the shift trade request.

6. The shift trading system of claim 5, wherein the operations further comprise notifying the source agent and the selected target agent about the change in schedule.

7. The shift trading system of claim 3, wherein the operations further comprise receiving, from a manager, an upper threshold value or a lower threshold value for one or more of the trade index score, the trade history success index score, the matching skill index score, the skill proficiency index score, or the trade interval index score.

8. The shift trading system of claim 7, wherein an upper threshold value and a lower threshold value for the trade index score are received and the operations further comprise:
determining that the trade index score is greater than or equal to the upper threshold value for the trade index score and automatically approving the shift trade request; or
determining that the trade index score is lower than or equal to the lower threshold value for the trade index score and automatically rejecting the shift trade request.

9. The shift trading system of claim 1, wherein the trade index score is further based on an adherence index score, and the operations further comprise:
receiving a weight for the adherence index score; and
applying the respective weight to the adherence index score.

10. A method for facilitating the trading of shifts between agents, which comprises:
receiving a shift trade request from a source agent, wherein the shift trade request comprises a shift day and a shift time;
matching the shift trade request with a plurality of target agents that are available on the shift day and the shift time;
for each target agent from the plurality of target agents, calculating a trade index score based on a trade history success index score, a matching skill index score, a skill proficiency index score, and a trade interval index score;
ranking the plurality of target agents from highest to lowest trade index score; and
displaying the ranked plurality of target agents with the target agent having the highest trade index score at the top of a list.

11. The method of claim 10, which further comprises:
receiving, from the source agent, a selection of a target agent;
transmitting the shift trade request to the selected target agent; and
receiving, from the selected target agent, an acceptance of the shift trade request.

12. The method of claim 11, which further comprises:
transmitting the shift trade request to a manager; and
displaying the trade index score, the trade history success index score, the matching skill index score, the skill proficiency index score, and the trade interval index score to the manager.

13. The method of claim 12, which further comprises:
receiving, from the manager, approval of the shift trade request; and
changing a schedule of the source agent and the selected target agent according to the shift trade request.

14. The method of claim 11, which further comprises receiving, from a manager, an upper threshold value or a lower threshold value for one or more of the trade index score, the trade history success index score, the matching skill index score, the skill proficiency index score, or the trade interval index score.

15. The method of claim 14, wherein an upper threshold value and a lower threshold value for the trade index score are received, and the method further comprises:
determining that the trade index score is greater than or equal to the upper threshold value for the trade index score and automatically approving the shift trade request; or
determining that the trade index score is lower than or equal to the lower threshold value for the trade index score and automatically rejecting the shift trade request.

16. A non-transitory computer-readable medium having stored thereon computer-readable instructions executable by a processor to perform operations which comprise:
receiving a shift trade request from a source agent, wherein the shift trade request comprises a shift day and a shift time;
matching the shift trade request with a plurality of target agents that are available on the shift day and the shift time;
for each target agent from the plurality of target agents, calculating a trade index score based on a trade history success index score, a matching skill index score, a skill proficiency index score, and a trade interval index score;
ranking the plurality of target agents from highest to lowest trade index score; and
displaying the ranked plurality of target agents with the target agent having the highest trade index score at the top of a list.

17. The non-transitory computer-readable medium of claim 16, wherein the operations further comprise:
receiving, from the source agent, a selection of a target agent;
transmitting the shift trade request to the selected target agent; and
receiving, from the selected target agent, an acceptance of the shift trade request.

18. The non-transitory computer-readable medium of claim 17, wherein the operations further comprise:
transmitting the shift trade request to a manager; and
displaying the trade index score, the trade history success index score, the matching skill index score, the skill proficiency index score, and the trade interval index score to the manager.

19. The non-transitory computer-readable medium of claim 18, wherein the operations further comprise:
receiving, from the manager, approval of the shift trade request; and
changing a schedule of the source agent and the selected target agent according to the shift trade request.

20. The non-transitory computer-readable medium of claim 17, wherein the operations further comprise:
receiving, from a manager, an upper threshold value and a lower threshold value for the trade index score; and
determining that the trade index score is greater than or equal to the upper threshold value for the trade index score and automatically approving the shift trade request; or
determining that the trade index score is lower than or equal to the lower threshold value for the trade index score and automatically rejecting the shift trade request.
